(19) United States
(12) Patent Application Publication
(10) Pub. No.: US 2006/0187132 A1
(43) Pub. Date: Aug. 24, 2006

(54) Radio wave timepiece

(76) Inventor: Shoji Nirasawa, Chiba-shi (JP)

Correspondence Address: BRUCE L. ADAMS, ESQ.;SUITE 1231, 17 BATTERY PLACE, NEW YORK, NY, 10004, US

(21) Appl. No.: 11/356,630

(22) Filed: Feb. 17, 2006

(30) Foreign Application Priority Data
Feb. 22, 2005 (JP) 2005-046098

(51) Int. Cl. H01Q 1/12

(52) U.S. Cl. 343/718

(57) ABSTRACT

In a radio wave timepiece having a fourth wheel & pinion receive pin as an essential constituent element of a hand attaching structure, to make a planar size thereof small. A radio wave timepiece includes a movement having a main plate and a train wheel bridge of a plastic member. The main plate is formed with an antenna containing recess portion bent along an outer periphery of a timepiece case. A ferrite antenna is contained in the antenna containing recess portion. A back side of the movement is arranged with an antenna cover functioning as a hand pushing receive seat of a plastic member. A metal pin is attached to a stepped through hole of an antenna cover by providing a certain constant distance from a front end of a fourth stem of a fourth wheel & pinion. Further, a plurality of push up projection are provided at an outer peripheral portion of the main plate which is not influenced by an arrangement of the ferrite antenna and also the antenna cover is provided with 1 piece of a push up projection.

### BACKGROUND OF THE INVENTION

1. Field of the Invention

The present invention relates to a radio wave timepiece having a fourth wheel & pinion receive pin as an essential constituent element of a hand attaching structure.

2. Description of the Prior Art

In a portable electronic timepiece of a background art, according to a movement using a train wheel bridge of a plastic member, when a second hand is attached thereto, a metal plate is brought into contact with a lower side of a fourth stem to thereby prevent a fourth wheel & pinion from being buckled by the train wheel bridge by attaching the hand. Further, when in view of a structure of the movement, a part having a height higher than the train wheel bridge is present and the fourth stem cannot be received, there is adopted a structure of providing a metal part such as a fourth wheel & pinion receive pin made of a metal at the lower portion of the fourth stem. For example, JP-A-2001-162333 discloses a portable electronic timepiece attaching a fourth wheel & pinion receive pin made of a metal to a battery frame by providing a certain distance from a fourth stem of the fourth wheel & pinion. A load in attaching a hand is applied to the fourth wheel & pinion and is transmitted to a train wheel bridge of a plastic member of the movement. Up to a constant load, a fourth wheel & pinion support portion of the train wheel bridge is elastically deformed, the fourth stem gradually approaches a receive face of the fourth wheel & pinion receive pin, and when the fourth stem reaches the receive face of the fourth wheel & pinion receive pin, the fourth wheel & pinion receive pin receives the load. The load applied from a flanged receive portion of the fourth wheel & pinion receive pin to a battery frame is applied to a case back push up projection of the battery frame and a base receive portion of the fourth wheel & pinion receive pin and is applied uniformly to a base on which the movement is placed. Thereby, respective hands of an hour hand, a minute hand and the second hand can be attached in a state of the movement.

Meanwhile, a portable electronic timepiece with an antenna constituted by newly arranging an antenna part to a movement of a background art, a so-to-speak portable radio wave timepiece has been developed, the antenna part is the largest in parts constituting the movement and therefore, with regard to a hand pushing structure, a problem described below is posed.

That is, as shown by a plane view of a back side of a movement of FIG. 4 and a sectional view directing the back side of the movement downward of FIG. 5, the portable radio wave timepiece having the fourth wheel & pinion receive pin made of a metal disclosed in JP-A-2000-162333 is constituted by including a main plate 4 in a circular shape formed with 6 pieces of push up projection 9 at an outer peripheral portion thereof, a circuit board 6 attached to the main plate 4, a train wheel held by a train wheel bridge 5 of a plastic member, an antenna 8 contained in an antenna containing recess portion 4a of the main plate 4, a battery frame 20 containing a battery 10, and a metal pin 12 attached to the battery frame 20. The metal pin 12 is a part functioning as a fourth wheel & pinion receive pin made of a metal.

The antenna containing recess portion 4a is formed in a shape of a circular arc over substantially near to a half periphery on an inner side of the outer peripheral portion of the main plate 4 formed with the push up projections 9. A position of forming the antenna containing recess portion 4a is disposed on a side opposed to the containing recess portion of the battery 10 relative to a center of the main plate 4 in the circular shape. The antenna 8 contained in the antenna containing recess portion 4a is constituted by winding a wire around an antenna core 8a in a shape of a circular arc having a section substantially in a square shape.

The battery frame 20 is a plastic plate member having substantially a triangular shape substantially covering a half of the main plate 4 in the circular shape. A right side thereof is a region formed with the antenna containing recess portion, and a left side thereof is a region having a circular arc proximate to the antenna containing recess portion 4a. The battery frame 20 arranged by being partially brought into contact with a back face of the circuit board 6. Therefore, the train wheel bridge 5 of the plastic member is arranged between the main plate 4 and the battery frame 20 by interposing the circuit board 6.

The antenna 8 is a large part having a section almost reaching the back side of the movement from a top side thereof. Therefore, a back face side of the antenna 8 is projected from a back face of the circuit board 6. An amount of projecting the antenna 8 from the back face of the circuit board 6 is about three times as much as a thickness of the circuit board 6.

The metal pin 12 is a flanged metal pin formed with a flange at one end thereof. Further, the battery frame 20 is formed with a stepped through hole 13 to be inserted with the metal pin 12 from an upper side. Other end of the metal pin 12 is projected from the back face of the battery frame 20. An amount of projecting the metal pin 12 from the back face of the metal pin 12 is about a half of a thickness of the battery frame 20.

The push up projections 9 formed integrally with the main plate 4 are arranged substantially symmetrically in a left and right direction by 3 pieces on a right side and 3 pieces on a left side at the outer peripheral portion of the main plate 4 in the circular shape at intervals there among. The push up projection 9 is a projection in a shape of a small circular cylinder having a front end portion in a conical shape. An amount of projecting the push up projection 9 from the back face of the battery frame 20 and therefore, an amount of projecting the push up projection 9 from the back face of the movement is made to be slightly larger than the amount of projecting the metal pin from the back face of the battery frame 20. In sum, a front end of the push up projection 9 is projected more than the back face side of the antenna and more than the front end of the metal pin 12.

In the above-described movement, an attaching operation of attaching an hour hand 16 to a front end of an hour wheel, attaching a minute hand 15 to a front end of a support shaft of a center wheel & pinion in a shape of a cylinder and attaching a second hand 14 to a front end of a support shaft of a force wheel & pinion, respectively, is carried out by an assembling operator by using a metal plate 17 for attaching the hands placed on an operation base. That is, as shown by FIG. 5, the movement assembled up to a state immediately before attaching the hands is mounted on the metal plate 17. Then, the front end portions of the push up projection 9 formed at the outer peripheral portion of the main plate 4 in the circular shape at substantially equal angular intervals are put into predetermined shallow mount holes formed at a surface of the hand attaching metal plate 17. At the same time, the front end of the metal pin 12 arranged at the stepped through hole 13 of the battery frame 20 is brought into contact with the surface of the hand attaching metal plate 17. Thereby, the assembling operator can carry out the operation of attaching the hands of the radio wave timepiece without buckling or destructing the train wheel bridge 5 of the plastic member and therefore, without destructing the antenna 8.

Next, FIG. 6 shows a hand attaching structure in which a case back 3 of an exterior of the radio wave timepiece is made to serve also as the above-described metal plate. In FIG. 6, constitutions of the antenna 8 and the movement are the same as those shown in FIG. 4 and FIG. 5, mentioned above. Owing to such a structure, the assembling operator can carry out the operation of attaching the hands of the radio wave timepiece without buckling or destructing the train wheel bridge of the plastic member and therefore, without destructing the antenna.

However, according to the above-described hand attaching structure of the background art, that is, the hand attaching structure in which the fourth wheel & pinion receive pin made of the metal is provided at the battery frame of the plastic member and the plurality of push up projections are provided at the outer peripheral portion of the main plate in the circular shape substantially at equal angular intervals, there poses a problem that a planar size becomes large. Because an extra space for providing the plurality of push up projections substantially at equal angular intervals is needed at the outer peripheral portion of the main plate in the circular shape. Conversely, when the planar size of the radio wave timepiece is not made to be large, a size of the antenna cannot be made to be large and therefore, there poses a problem that a necessary receiving sensitivity cannot be ensured.

Further, although accordion to the radio wave timepiece having the above-described hand attaching structure of the background art in which the fourth wheel & pinion receive pin made of the metal is provided at the battery frame of the plastic member and the plurality of push up projections are provided at the outer peripheral portion of the main plate in the circular shape substantially at equal angular intervals, the battery frame of the plastic member substantially in the triangular shape covering the half of the main plate in the circular shape is adopted, an outer edge of the region on a side opposed to the region formed with the battery containing recess portion is proximate to the antenna containing recess portion. Therefore, the antenna is exposed on the back face side of the movement. Therefore, there also poses a problem that the assembling operator is erroneously brought into contact with the antenna.

It is a problem to be resolved by the invention to make a planar size of a radio wave timepiece small and prevent an antenna from being exposed from an antenna containing recess portion in the radio wave timepiece having a fourth wheel & pinion receive pin made of a metal as an essential constituent element of a hand attaching structure.

### SUMMARY OF THE INVENTION

In order to resolve the above-described problem, there is provided a radio wave timepiece including a movement having a main plate in a circular shape and a train wheel bridge of a plastic member and containing an antenna at an antenna containing recess portion of the main plate, wherein the antenna containing recess portion is formed at an outer peripheral portion of the main plate to be proximate to an outer edge thereof, a hand pushing receive seat of a plastic member is arranged on a back side of the movement, a fourth wheel & pinion receive pin is attached to the hand pushing receive seat of the plastic member by providing a certain constant distance from a fourth stem of the fourth wheel & pinion, and a plurality of push up projections are provided at the outer peripheral portion of the main plate which is not influenced by an arrangement of the antenna.

### BRIEF DESCRIPTION OF THE SEVERAL VIEWS OF THE DRAWINGS

A preferred form of the present invention is illustrated in the accompanying drawings in which:

FIG. 1 is a plane view of a back side of a movement according to Embodiment 1 of the invention;

FIG. 2 is a sectional view directing the back side of the movement of Embodiment 1 of the invention downward;

FIG. 3 is a sectional view directing a back side of a movement of a modified example of Embodiment 1 of the invention downward;

FIG. 4 is a plane view of a back side of a movement of a radio wave timepiece of a background art;

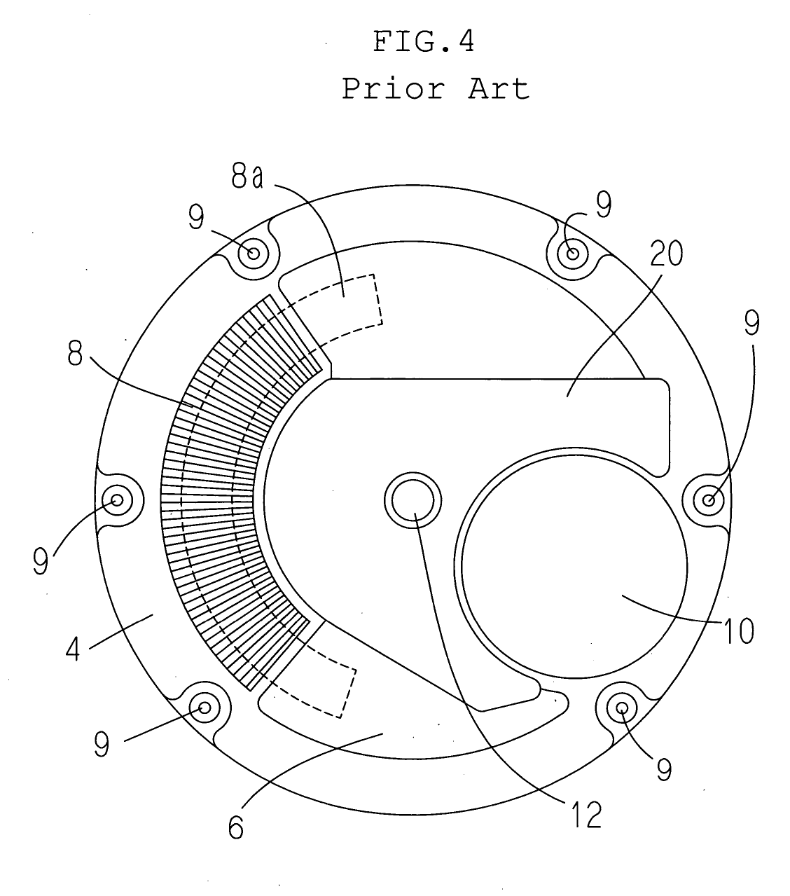

FIG. 5 is a sectional view directing the back side of the movement of the radio wave timepiece of the background art downward; and

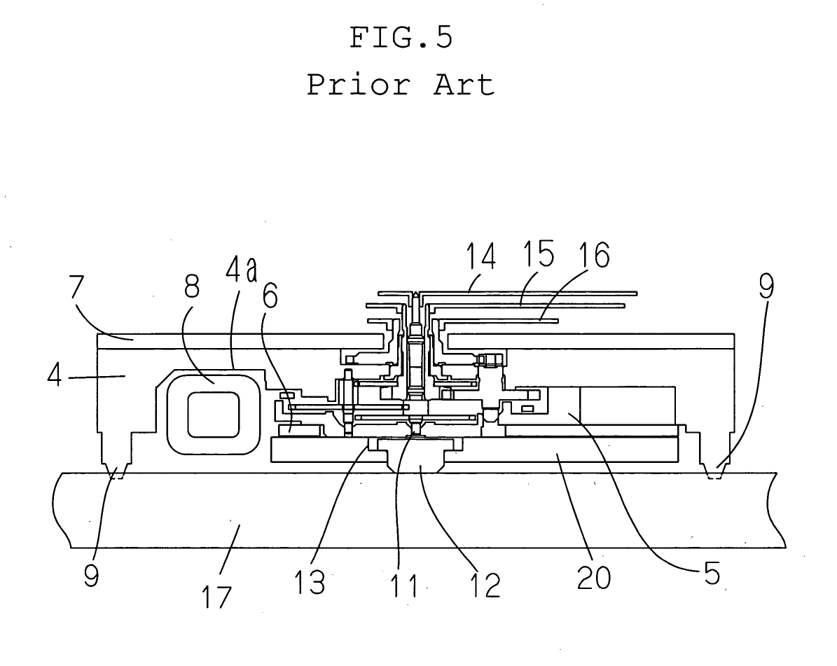

FIG. 6 is a sectional view directing a back side of a movement of a modified example of the radio wave timepiece of the background art downward.

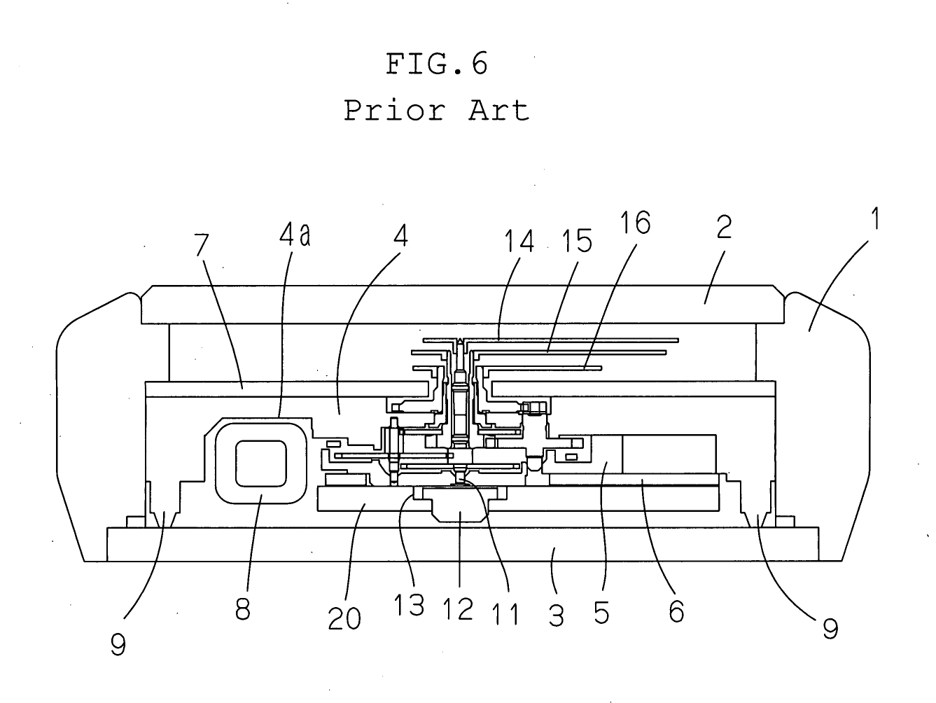

### DETAILED DESCRIPTION OF THE PREFERRED EMBODIMENTS

According to the invention, in a radio wave timepiece including a movement having a main plate in a circular shape and a train wheel bridge of a plastic member and containing an antenna at an antenna containing recess portion of the main plate, the antenna containing recess portion is formed at an outer peripheral portion of the main plate by making an outer edge thereof proximate thereto. Further, a hand pushing receive seat of a plastic member is arranged on a back side of the movement, and a fourth wheel & pinion pin is attached to the hand pushing receive seat of the plastic member by providing a certain constant distance from a fourth stem of a fourth wheel & pinion. Further, a plurality of push up projections are provided at the outer peripheral portion of the main plate which is not influenced by an arrangement of the antenna.

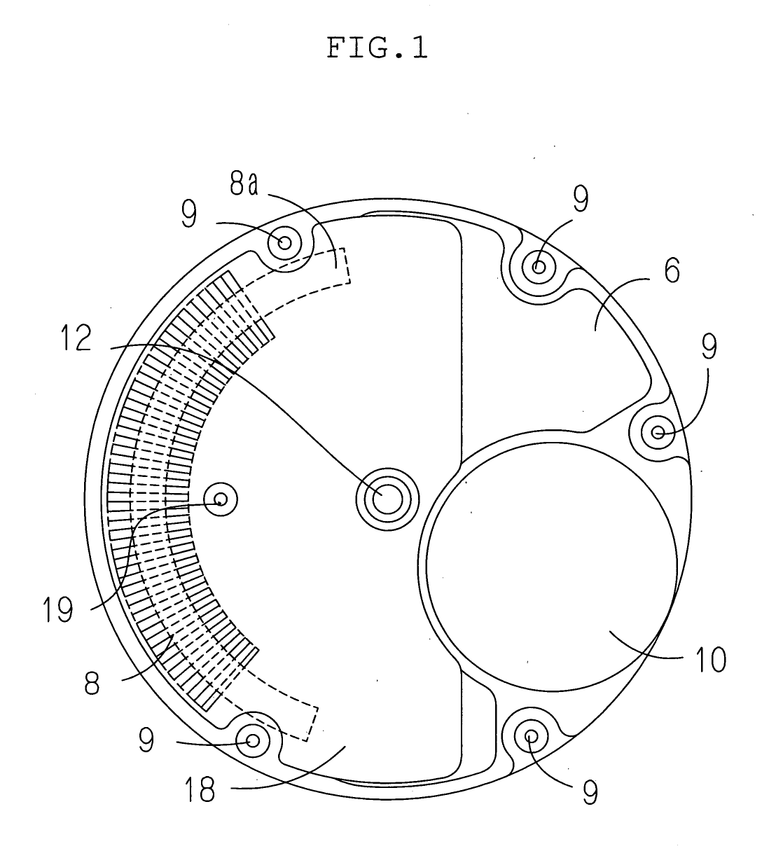

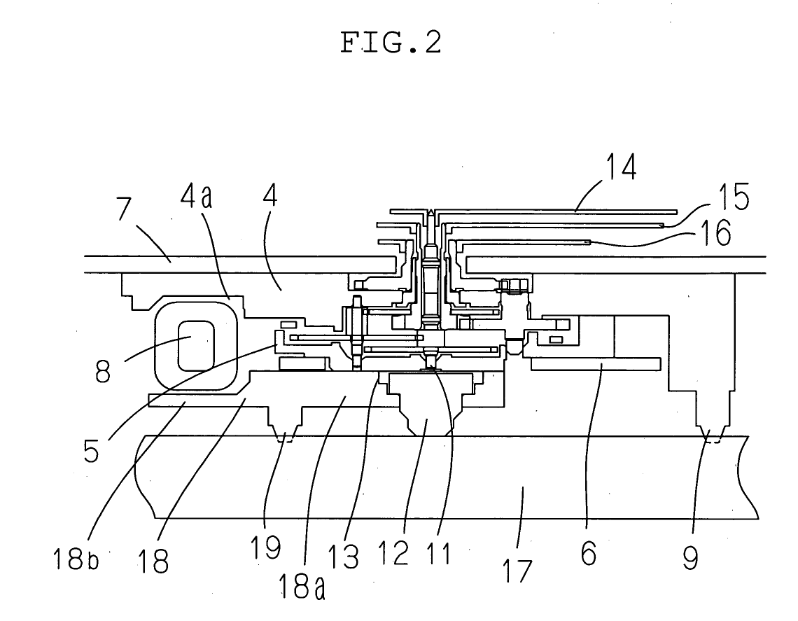

As shown by a plane view of a back side of a movement of FIG. 1, and a sectional view directing a back side of the movement downward of FIG. 2, a portable radio wave timepiece of Embodiment 1 of the invention is constituted by including a main plate 4 in a circular shape formed with 5 pieces of push up projection 9 at an outer peripheral portion thereof, a circuit board 6 attached to the main plate 4, a train wheel held by a train wheel bridge 5 of a plastic member, an antenna 8 contained in an antenna containing recess portion 4 of the main plate 4, an antenna cover 18 functioning as a hand pushing receive seat of a plastic member, a metal pin 12 attached to the antenna cover 18, and a battery contained in a battery containing recess portion. The metal pin 12 is a part functioning as a fourth wheel & pinion receive pin made of a metal. Further, it is not necessary that the metal pin 12 is made of a metal so far as a function similar to that of the metal pin is provided and a pin made of a plastic may be used in place of the metal pin 12.

An antenna containing recess portion 4a is formed in a shape of circular arc at the main plate 4 over near to substantially a half periphery thereof by being partially put into an outer peripheral portion of the main plate 4 formed with the push up projection 9. That is, the antenna containing recess portion 4a is formed at the outer peripheral portion of the main plate 4 in the circular shape to be proximate to an outer edge thereof. A position of forming the antenna containing recess portion 4a is disposed on a side opposed to a containing recess portion of a battery 10 relative to a center of the main plate 4 in the circular shape. The antenna 8 contained in the antenna containing recess portion 4a is constituted by winding a wire around a ferrite core 8a in a shape of a circular arc having a section substantially in a square shape.

The antenna cover 18 is a plastic plate member substantially in a shape of a circular arc substantially covering about three quarters of the main plate 4 in the circular shape and is arranged to be partially brought into contact with a back face of the circuit board 6. Therefore, the train wheel bridge 5 of the plastic member is arranged between the main plate 4 and the antenna cover 18 by interposing the circuit board 6 therebetween. An outer peripheral region of the antenna cover 18, that is, an antenna cover portion 18b totally covers the bent antenna 8 contained in the antenna containing recess portion 4a at the back side of the movement.

The antenna 8 is a large part having a section almost reaching a back side of the movement from a top side thereof. Therefore, a back face side of the antenna 8 is projected from the back face of the circuit board 6. An amount of projecting the antenna 8 from the back face of the circuit board 6 is about three times as much as a thickness of the circuit board 6.

The metal pin 12 is a flanged metal pin formed with a flange at one end thereof. Further, the antenna cover 18 functioning as a hand pushing receive seat of the plastic member is formed with a stepped through hole 13 constituted by inserting a flanged metal pin into a hand pushing receive seat portion 18a from an upper side. Other end of the pin 12 made of a metal is projected from a back face of the antenna cover 18. An amount of projecting the metal pin 12 from the back face of the antenna cover 18 is to a degree of being the same as a thickness of the hand pushing receive seat portion 18a of the antenna cover 18.

The push up projections 9 formed integrally with the main plate 4 are arranged at the outer peripheral portion of the main plate in the circular shape by 3 pieces thereof on a right side and 2 pieces thereof on a left side. Further, also the antenna cover 18 is provided with 1 piece of a push up projection 19. A position of providing the push up projection 19 is disposed at a center of a circular arc of the hand pushing receive seat portion 18a contiguous to the antenna cover portion 18b. The push up projections 9 and 19 are projections in a shape of a small circular cylinder having front end portions in a conical shape. An amount of projecting the push up projections 9 and 19 from the back face of the antenna cover 18 is slightly larger than the amount of projecting the metal pin 12 from the back face of the antenna cover 18. In sum, front ends of the push up projections 9 and 19 are projected more than a back face side of the antenna 8 and projected more than a front end of the metal pin 12.

In the above-described movement, an attaching operation of attaching an hour hand 16 to a front end of an hour wheel, attaching a minute hand 15 to a front end of a support shaft of a center wheel & pinion in a shape of a cylinder and attaching a second hand 14 to a front end of a support shaft of a fourth wheel & pinion, respectively, is carried out by an assembling operator by using a hand attaching metal plate 17 placed on an operation base. That is, as shown by FIG. 2, the movement assembled up to a state immediately before attaching the hands is mounted on the metal plate 17. Then, front end portions of the push up projections 9 formed at the outer peripheral portion of the main plate 4 in the circular shape substantially at equal angular intervals and a front end portion of the push up projection 19 formed at the antenna cover 18 are put into predetermined shallow mount holes formed at a surface of the hand attaching metal plate 17. At the same time, the front end of the metal pin 12 arranged at the stepped trough hole 13 of the antenna cover 18 is brought into contact with the surface of the hand attaching metal plate 17. Thereby, the assembling operator can carry out the hand attaching operation of the radio wave timepiece without buckling or destructing the train wheel bridge 5 of the plastic member and therefore, without destructing the antenna.

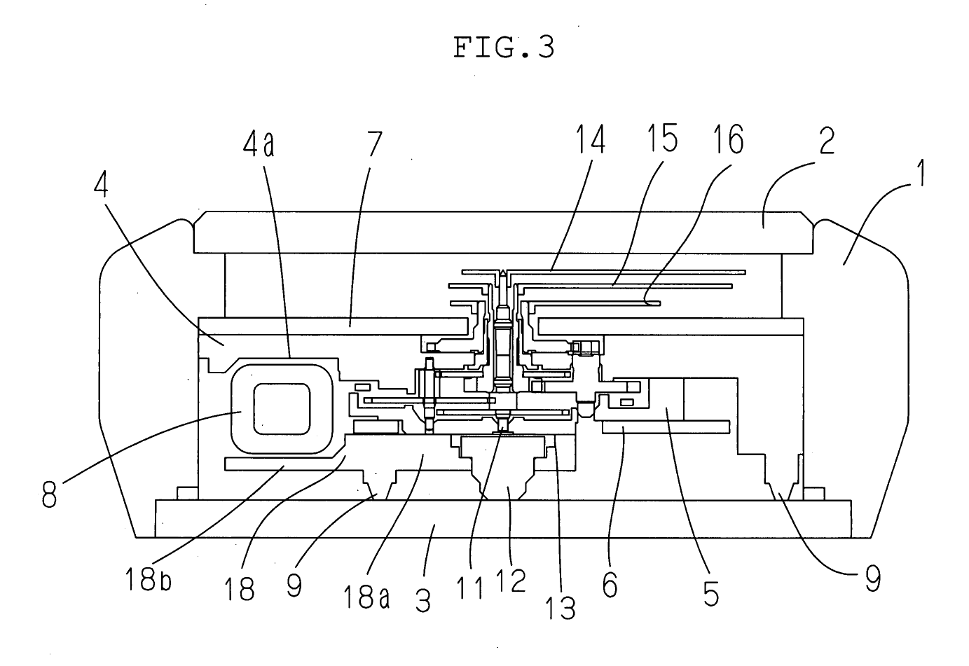

Next, FIG. 3 is a sectional view directing a back side of the movement of a modified example of Embodiment 1 downward. That is, the radio wave timepiece of the modified example of Embodiment 1 is characterized in that a case back 3 is made to serve also as the metal plate 17 of Embodiment 1 in the radio wave timepiece constituted by the main plate 4 in the circular shape formed with 5 pieces of the push up projections at the outer peripheral portion, the circuit board 6 attached to the main plate 4, the train wheel held by the train wheel bridge 5 of the plastic member, the antenna 8 contained in the antenna containing recess portion 4a of the main plate 4, the antenna cover 18 which is a member functioning as the hand pushing receive seat of the plastic member and formed with 1 piece of push up projection 19, the metal pin 12 attached to the antenna cover 18, and the battery 10 contained in the battery containing recess portion. Owing to the structure, the assembling operator can carry out the hand attaching operation of the radio wave timepiece without buckling or destructing the train wheel bridge 5 of the plastic member and therefore, without destructing the antennas.

By the invention, in the radio wave timepiece including the fourth wheel & pinion receive pin as an essential constituent element of a hand attaching structure, a planar size of the radio wave timepiece can be made to be small and the antenna can be prevented from being exposed from the antenna containing recess portion. Further, the hand pushing receive seat of the plastic member attached with the fourth wheel & pinion receive pin is made to serve as an antenna cover and therefore, an increase in the number of pieces of parts can be restrained.

What is claimed is:

1. A radio wave timepiece comprising:
a movement having a main plate in a circular shape and a train wheel bridge of a plastic member; and
an antenna being containing at an antenna containing recess portion of the main plate;
wherein the antenna containing recess portion is formed at an outer peripheral portion of the main plate to be proximate to an outer edge thereof, a hand pushing receive seat of a plastic member is arranged on a back side of the movement, a fourth wheel & pinion receive pin is attached to the hand pushing receive seat of the plastic member by providing a certain constant distance from a fourth stem of the fourth wheel & pinion, and a plurality of push up projections are provided at the outer peripheral portion of the main plate which is not influenced by an arrangement of the antenna.

2. A radio wave timepiece according to claim 1, wherein a push up projection is provided at the hand pushing receive seat of the plastic member.

3. A radio wave timepiece according to claim 1, wherein the hand pushing receive seat of the plastic member is made to serve also as an antenna cover.
